(19) United States
(12) Patent Application Publication
(10) Pub. No.: US 2026/0170706 A1
(43) Pub. Date: Jun. 18, 2026

(54) IMAGE PROCESSING APPARATUS AND IMAGE PROCESSING METHOD

(71) Applicant: Sony Interactive Entertainment Inc., Tokyo (JP)

(72) Inventor: Shigeatsu YOSHIOKA, Kanagawa (JP)

(73) Assignee: Sony Interactive Entertainment Inc., Tokyo (JP)

(21) Appl. No.: 19/119,108

(22) PCT Filed: Oct. 24, 2022
(86) PCT No.: PCT/JP2022/039441

§ 371 Date: Apr. 8, 2025

(51) Int. Cl. G06T 11/00

(52) U.S. Cl. CPC G06T 11/00

(57) ABSTRACT

A local-generation area determining section of an image processing apparatus determines local-generation areas such that the local-generation areas are suited for the processing capability of the image processing apparatus on the basis of variable ranges of images from a frame as the base point. An image generating apparatus generates images of the local-generation areas. An input information transmitting section transmits information about user operation to a content server. A data acquiring section acquires data of a frame generated and transmitted by the content server. A synthesizing section synthesizes images from the content server and the images of the local-generation areas. An output section outputs data of a synthesized frame.

### TECHNICAL FIELD

The present invention relates to an image processing apparatus that processes data from a server and causes the data to be displayed, and an image processing method.

### BACKGROUND ART

With enrichment of communication networks and advances in image processing technology in recent years, it has become possible to enjoy a variety of pieces of electronic content no matter what a viewing/listening environment is. For example, in the field of electronic games, there has been widespread use of systems that allow a plurality of players to participate in the same game no matter where locations of the players are. The Systems realize this by collecting, at a server, operation information input to individual client terminals, and distributing game images reflecting the operation information successively.

### SUMMARY

### Technical Problem

The adequate processing environment of the server can be exploited not only for electronic games, but for electronic content in a format in which moving images generated in real time in response to user operation are distributed from a server. Accordingly, it becomes easier to display high-quality images which are least influenced by the processing performance of client terminals. On the other hand, processes of transmission of operation information from the client terminals and distribution of videos from the server in response to the operation information are always involved, and it is possible that a problem related to responsiveness of display images to the user operation occurs.

The present invention has been made in view of such problems, and an object thereof is to provide a technology that realizes both image quality and responsiveness in image processing on electronic content involving distribution from a server.

### Solution to Problem

In order to solve the problems described above, an aspect of the present invention relates to an image processing apparatus. The image processing apparatus includes one or more processors having hardware, in which the one or more processors acquire data of a moving image from a server, determine, as a local-generation area, an area where an image is generated locally on a plane of a frame of the moving image, on the basis of a content of the frame as a base point, generate an image of the local-generation area, synthesize an image acquired from the server and the image of the local-generation area for each frame, and output data of a frame formed by synthesis.

Another aspect of the present invention relates to an image processing method. The image processing method includes acquiring data of a moving image from a server, determining, as a local-generation area, an area where an image is generated locally on a plane of a frame of the moving image on the basis of a content of the frame as a base point, generating an image of the local-generation area, synthesizing an image acquired from the server and the image of the local-generation area for each frame, and outputting data of a frame formed by synthesis.

Note that any combinations of the constituent elements mentioned above, and ones obtained by converting expressions of the present invention between a method, an apparatus, a system, a computer program, a data structure, a recording medium, and the like also are valid as aspects of the present invention.

### Advantages Effect of Invention

The present invention makes it possible to realize both image quality and responsiveness in image processing on electronic content involving distribution from a server.

### BRIEF DESCRIPTION OF DRAWINGS

FIG. 1 is a figure depicting a configuration example of an image display system to which the present embodiment can be applied.

FIG. 2 is a figure depicting an internal circuit configuration of an image processing apparatus in the present embodiment.

FIG. 3 is a figure depicting a configuration of functional blocks of an image processing apparatus and a content server in the present embodiment.

FIG. 4 is a flowchart depicting a processing procedure performed by an image processing apparatus and the content server to output images of content in the image display system of the present embodiment.

FIG. 5 is a figure for explaining a summary of an image generation technique and the principle of determination of local-generation areas in the present embodiment.

FIG. 6 is a figure for explaining a local-generation area determination technique assuming that there are more complex objects in the present embodiment.

FIG. 7 is a figure depicting an example of a frame at a time t as the base point in explanation of the present embodiment.

FIG. 8 is a figure for explaining a procedure performed by a local-generation area determining section to determine local-generation areas in the frame depicted in FIG. 7.

FIG. 9 is a figure depicting examples of local-generation areas determined on the basis of variable ranges depicted in FIG. 8 and areas for which data is requested from the content server.

FIG. 10 is a figure for explaining images determined by ray tracing that can be used in the present embodiment.

FIG. 11 is a time chart depicting the temporal relation in processes ranging from generation to displaying of each frame in the present embodiment.

FIG. 12 is a figure for explaining a synthesis process performed by a synthesizing section in the present embodiment.

FIG. 13 is a figure for explaining another example of the synthesis process performed by the synthesizing section in the present embodiment.

### DESCRIPTION OF EMBODIMENT

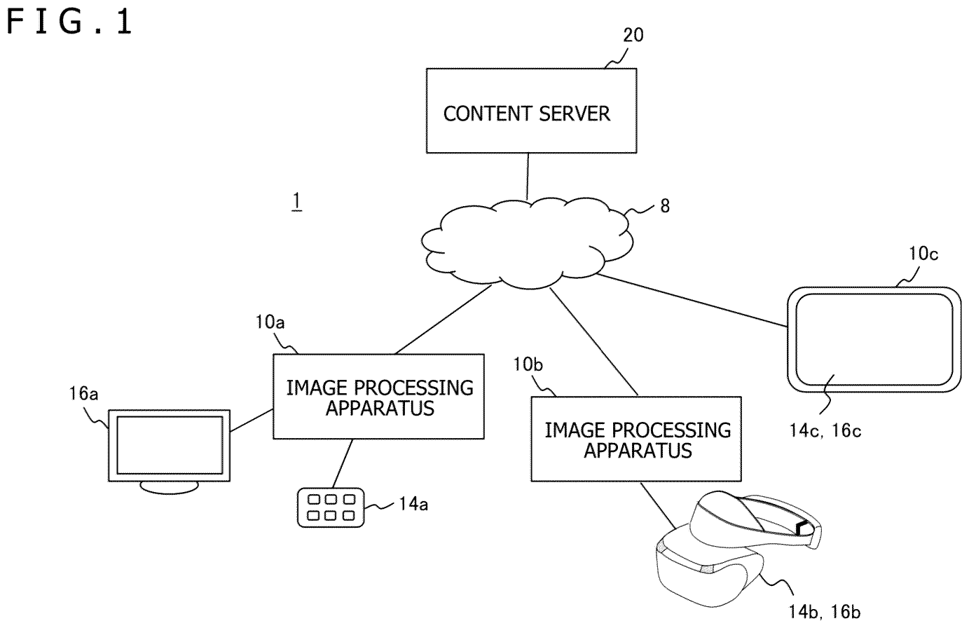

FIG. 1 depicts a configuration example of an image display system to which the present embodiment can be applied. An image display system 1 includes image processing apparatuses 10a, 10b, and 10c that cause images to be displayed in response to user operation, and a content server 20 that provides image data to be used for displaying. The image processing apparatuses 10a, 10b, and 10c are connected with input apparatuses 14a, 14b, and 14c for user operation and display apparatuses 16a, 16b, and 16c that display images, respectively. The image processing apparatuses 10a, 10b, and 10c and the content server 20 can establish communication via a network 8 such as a WAN (World Area Network) or a LAN (Local Area Network).

The image processing apparatuses 10a, 10b, and 10c may be connected with the display apparatuses 16a, 16b, and 16c, respectively, and the input apparatuses 14a, 14b, and 14c, respectively, either through wires or wirelessly. Alternatively, two or more of these apparatuses may be formed integrally. For example, in the figure, the image processing apparatus 10b is connected with a head-mount display which is the display apparatus 16b. Since the head-mount display can change the visual field of display images depending on motions of a user who has the head-mount display on her/his head, the head-mount display functions also as the input apparatus 14b.

In addition, the image processing apparatus 10c is a mobile terminal, and is configured integrally with the display apparatus 16c and the input apparatus 14c, which is a touch pad covering the screen of the display apparatus 16c. In this manner, the appearance shapes and modes of connection of the depicted apparatuses are not limited. The number of the image processing apparatuses 10a, 10b, and 10c and the content server 20 connected to the network 8 also is not limited to any particular shape and mode. Hereinafter, the image processing apparatuses 10a, 10b, and 10c are collectively referred to as image processing apparatuses 10, the input apparatuses 14a, 14b, and 14c are collectively referred to as input apparatuses 14, and the display apparatuses 16a, 16b, and 16c are collectively referred to as display apparatuses 16.

Each input apparatus 14 may be any of typical input apparatuses such as a controller, a keyboard, a mouse, a touch pad, and a joystick and various types of sensors such as a motion sensor and a camera included in a head-mount display, or may be a combination of these. The input apparatus 14 supplies a content of user operation to an image processing apparatus 10. Each display apparatus 16 may be a typical display such as a liquid crystal display, a plasma display, an organic electro-luminescence (EL) display, a wearable display, or a projector, and displays images output from an image processing apparatus 10.

The content server 20 provides data of content involving image displaying to the image processing apparatuses 10. The type of the content is not limited particularly, and may be any of an electronic game, images for appreciation, webpages, video chatting by avatars, or the like. In the present embodiment, the content server 20 realizes streaming basically by generating data of moving images and sounds representing content, and also immediately transmitting the data to the image processing apparatuses 10.

At this time, the content server 20 serially acquires, from the image processing apparatuses 10, information about user operation on the input apparatuses 14, and causes the user operation to be reflected in the images and the sounds. This makes it possible for a plurality of users to participate in the same game, communicate with each other in a virtual world, and so on. Here, for example, the content server 20 generates high-quality images by three-dimensional computer graphics (3DCG).

In the field of 3DCG, image expression that gives a sense of realism has become possible by more accurately expressing physical phenomena that occur in a display-target space. Ray tracing is known as physically based rendering to realize this. In ray tracing, changes of color tones and luminance according to viewpoints and motions of objects themselves can be expressed more realistically by accurately computing propagation of various rays that reach a virtual viewpoint such as diffuse reflection or specular reflection on object surfaces, in addition to rays from light sources.

The image display system 1 of the present embodiment makes it possible to generate high-resolution images using ray tracing, and cause the images to be displayed at a high rate using an adequate processing environment of the content server 20 even if the processing performance of the image processing apparatuses 10 is low. On the other hand, if a user performs operation on an image being displayed, latency which cannot be overlooked can be generated from the user operation until displaying due to a processing procedure in which the content server 20 receives information about the user operation via the network 8, causes the user operation to be reflected in images and sounds, and transmits the images and the sounds again to the image processing apparatuses 10 via the network 8.

In view of this, in the present example embodiment, it is attempted to realize both image quality and responsiveness by providing, on a frame plane of a moving image, portions to be generated by each of the image processing apparatuses 10 locally and portions to use data from the content server 20. That is, each image processing apparatus 10 generates images of some areas on a frame plane locally, synthesizes the images with images acquired from the content server 20, forms one frame, and then outputs the frame to the display apparatus 16.

Here, the areas for which the image processing apparatus 10 generates images are determined on the basis of the processing performance of the image processing apparatus 10 itself and the content of the images, e.g., the characteristics of objects to be represented as the images. For example, the image processing apparatus 10 renders, locally as much as possible, objects whose images on the frame plane make large motions, depending on user operation or changes of the viewpoint/line of sight. Further, data transmitted from the content server 20 is used for other areas such as the background, and both the data and the images generated by the image processing apparatus 10 are synthesized, and output to the display apparatus 16.

Thereby, images for which responsiveness is required such as images of objects that move in response to user operation, and images whose motions are noticeable can be displayed with short delays, without waiting for data transmission from the content server 20. Here, the area sizes of areas for which image processing apparatuses 10 generate images are determined adaptively depending on the processing performance of the individual image processing apparatuses 10 such that the condition that the image quality can be maintained is met. For other areas, images from the content server 20 with guaranteed quality are used. As a result, it is possible to realize both image quality and responsiveness with the minimum influence of the processing performance of the image processing apparatuses 10. Hereinafter, areas on the plane of a display-target frame for which the image processing apparatuses 10 generate images are called “local-generation areas.”

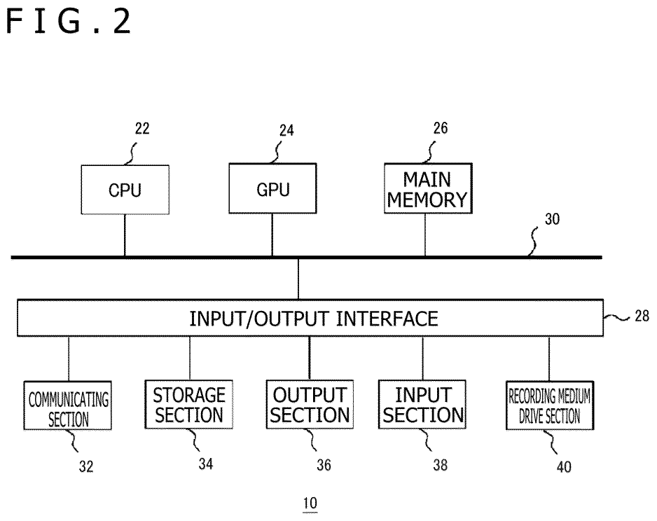

FIG. 2 depicts the internal circuit configuration of an image processing apparatus 10. The image processing apparatus 10 includes a CPU (Central Processing Unit) 22, a GPU (Graphics Processing Unit) 24, and a main memory 26. These respective sections are interconnected via a bus 30. The bus 30 is further connected with an input/output interface 28. The input/output interface 28 is connected with a communicating section 32 including a peripheral equipment interface such as a universal serial bus (USB) interface or an Institute of Electrical and Electronics Engineers (IEEE) 1394 interface and a wired or wireless LAN network interface, a storage section 34 such as a hard disk drive or a non-volatile memory, an output section 36 that outputs data to the display apparatus 16, an input section 38 through which data is input from the input apparatus 14, and a recording medium drive section 40 that drives a removable recording medium such as a magnetic disk, an optical disc, or a semiconductor memory.

The CPU 22 performs the overall control of the image processing apparatus 10 by executing an operating system stored on the storage section 34. The CPU 22 also executes various types of programs that are read out from a removable recording medium, and loaded onto the main memory 26, or are downloaded via the communicating section 32. The GPU 24 has a geometry engine function and a rendering processor function, performs a rendering process in accordance with a rendering command from the CPU 22, and stores display images in an undepicted frame buffer. Further, the GPU 24 converts display images stored in the frame buffer into a video signal, and outputs the video signal to the output section 36. The main memory 26 includes a RAM (Random Access Memory) and the like, and stores programs and data necessary for processes. The content server 20 also may have a similar internal circuit configuration.

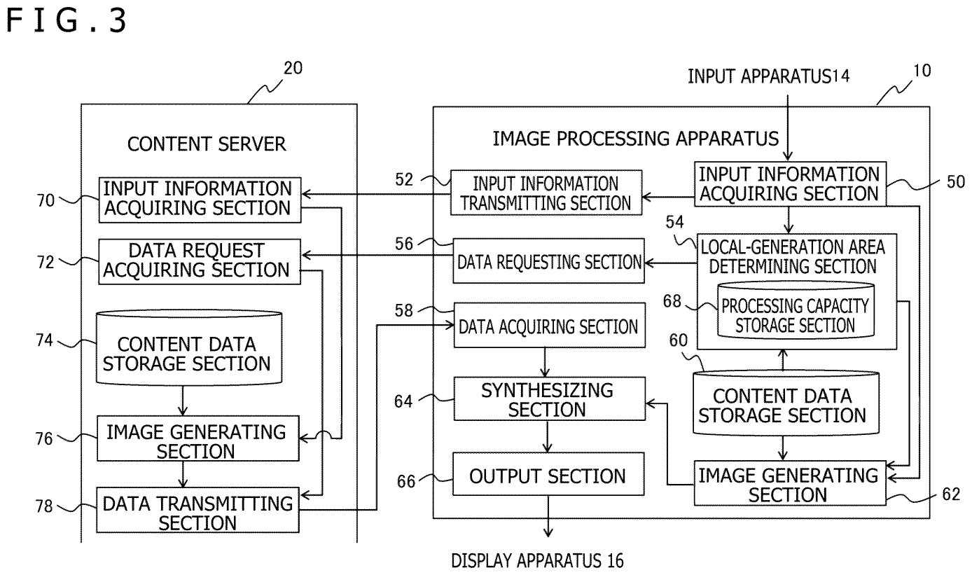

FIG. 3 depicts the configuration of functional blocks of an image processing apparatus 10 and the content server 20 in the present embodiment. Note that the image processing apparatus 10 and the content server 20 may perform various types of processing necessary for implementation of content such as sound processing, but the figure mainly depicts functional blocks related to image processing.

The depicted functional blocks can be realized hardware-wise by configurations such as the CPU, the GPU, and the various types of memories depicted in FIG. 2, and are realized software-wise by programs that are loaded onto a memory from a recording medium or the like and exhibit functions such as a data input function, a data retaining function, an image processing function, and a communication function. Accordingly, it is understood by those skilled in the art that these functional blocks can be realized in various forms such as by only hardware, by only software, or by a combination of them, and forms in which the functional blocks can be realized are not limited to any of them.

The image processing apparatus 10 includes an input information acquiring section 50 that acquires the content of user operation, an input information transmitting section 52 that transmits the content of the user operation to the content server 20, a local-generation area determining section 54 that determines local-generation areas, a data requesting section 56 that requests data of images from the content server 20, and a data acquiring section 58 that acquires the data of the images from the content server 20. The image processing apparatus 10 further includes a content data storage section 60 that stores data to be used for determination of local-generation areas and generation of images therefor, an image generating section 62 that generates the images of the local-generation areas, a synthesizing section 64 that synthesizes the images acquired from the content server 20 and the images of the local-generation areas, and an output section 66 that outputs data of a frame obtained after the synthesis to the display apparatus 16.

The input information acquiring section 50 acquires the content of user operation on the input apparatus 14. Here, the user operation may include selection of content, activation and deactivation of applications, and various types of operation on content. The input information transmitting section 52 successively transmits, to the content server 20, information related to the user operation acquired by the input information acquiring section 50.

The local-generation area determining section 54 determines local-generation areas for each frame or for each plurality of frames. Here, the local-generation area determining section 54 includes a processing capacity storage section 68 that retains a setting value of a permitted processing amount (processing capacity) that can be used for generation of images at the image processing apparatus 10. For example, the processing capacity is represented by the area size of images that the image processing apparatus 10 can render within time permitted for generation of one frame or by the number of pixels of the images.

For example, in a case where images are generated by ray tracing, the processing amount is proportional to the number of pixels. Accordingly, the number of pixels that can be generated for one frame can be estimated easily on the basis of the processing capability of the GPU 24 or the like of the image processing apparatus 10 and the display frame rate. Note that this is not aimed to limit image generation means to ray tracing in the present embodiment.

The local-generation area determining section 54 determines local-generation areas on a frame plane such that the processing capacity set in the processing capacity storage section 68 is not exceeded. That is, the local-generation area determining section 54 controls the area size of local-generation areas according to the processing capacity. By performing control in this manner, the local-generation area determining section 54 determines local-generation areas on the basis of variable ranges of images of objects on the frame plane. Specifically, the local-generation area determining section 54 gives objects the highest priority ranks in descending order of variable ranges. In addition, the local-generation area determining section 54 sets, as a local-generation area candidate, an area obtained by adding a variable range of each object to the image of the object in the last generated frame or an area including the minimum number of tile images including the thus-obtained area.

Further, the local-generation area determining section 54 selects one or more objects in descending order of the priority ranks such that the total area size of local-generation area candidates does not exceed the processing capacity. Further, the local-generation area determining section 54 determines, as local-generation areas of the next frame, local-generation area candidates corresponding to the selected objects. Here, each “variable range” is a two-dimensional area including a range within which the outline of an image of an object varies or a range within which the outline of the image of the object may vary until the next frame, and is typically formed around the current image. Accordingly, the “size of a variable range” means the area size of the area of the variable range.

In addition, each “object” may be one individual body such as a human or an object or may be a portion included in an individual body. In a case where a local-generation area is set, a plurality of individual bodies or a plurality of portions included in the plurality of individual bodies may collectively recognized as an “object.” In a case where 3DCG is generated by ray tracing or the like, the local-generation area determining section 54 first identifies or predicts a motion of an object to be made until the next frame in a display-target three-dimensional space.

For example, in the case of an object that moves in response to user operation, the local-generation area determining section 54 acquires, from the input information acquiring section 50, the content of operation that is actually performed by a user, and gives the object a motion in a three-dimensional space according to the content of operation. Further, a variable range of the image is estimated by projecting a three-dimensional range of motion onto a view screen of a display image. Alternatively, the local-generation area determining section 54 acquires all types of possible operation before a user performs operation, and derives an expected range of motion including all motions of the object that will be made in a case where every type of operation is performed. Further, the local-generation area determining section 54 estimates the maximum variable range of the image by projecting the expected range onto the view screen.

As for an object that moves independently of user operation, the local-generation area determining section 54 estimates a variable range of the image by identifying a range of pre-programmed motions, and projecting the variable range onto the view screen. In either case, the local-generation area determining section 54 finally determines a variable range and a local-generation area candidate for each object by taking into account also a variable range of the image caused by a translational movement, rotation, a scale factor change of the view screen itself due to a change of a virtual viewpoint or line of sight relative to a display-target space.

Operation that users are allowed to perform, motions of objects in response to each type of operation, automatic motions of objects, and the like are typically specified in an application of content. Accordingly, the local-generation area determining section 54 determines local-generation areas as mentioned above with reference to an application program of content stored on the content data storage section 60 or the like.

Note that, in the case of an image processing apparatus 10 with a low processing capability, there can be a case where the processing capacity is exceeded undesirably even with a local-generation area candidate of one object. At this time, the local-generation area determining section 54 does not have to set a local-generation area. In this case, displaying is performed at the image processing apparatus 10 using only data transmitted from the content server 20.

On the contrary, in the case of an image processing apparatus 10 with a high processing capability whose processing capacity is not exceeded even if a whole frame is rendered, the local-generation area determining section 54 may set the whole area as a local-generation area. In this case, the image processing apparatus 10 does not request data from the content server 20, and performs displaying using only data generated by the image processing apparatus 10 itself. In addition, even for the same image processing apparatus 10, processing performed by setting local-generation areas and processing performed without setting local-generation areas may be switched depending on the sizes of images of objects, variation of the processing capability, and the like.

The data requesting section 56 requests data of images from the content server 20. For example, for each frame of a moving image, the data requesting section 56 transmits, to the content server 20, a request signal designating areas necessary for displaying in units of tile images formed by dividing the frame plane into a predetermined size. In this case, the data requesting section 56 may keep the size of requested image data low and save the communication bandwidth by requesting only data of areas excluding some or all of local-generation areas. Alternatively, the data requesting section 56 may always request image data of a whole frame from the content server 20.

The data acquiring section 58 acquires data of images transmitted from the content server 20 according to a request from the data requesting section 56. For example, the data acquiring section 58 acquires data in units of tile images mentioned above, and reconstructs a frame by expanding the data in the original two-dimensional array in an undepicted frame memory.

The image generating section 62 generates images of local-generation areas on the basis of a program of content or model data of objects stored on the content data storage section 60, and the content of user operation acquired by the input information acquiring section 50. Suitably, the image generating section 62 renders, with high quality, areas with sizes suited for the processing capability by a physically based rendering technique such as ray tracing. In a case where data is acquired in units of tile images from the content server 20, local-generation areas also may be generated in units of tile images by the image generating section 62.

The synthesizing section 64 synthesizes images transmitted from the content server 20 and images of local-generation areas generated by the image generating section 62, and completes a frame representing a display image. In a case where tile images excluding some or all of local-generation areas are requested from the content server 20, the synthesizing section 64 connects tile images of local-generation areas and transmitted tile images at appropriate positions. In a case where an image of a whole frame is requested from the content Server 20, the synthesizing section 64 updates areas corresponding to local-generation areas in a transmitted image with images generated by the image generating section 62.

Images transmitted from the content server 20 represent an image world at a time point which is earlier by time required as communication time or the like, with respect to images of local-generation areas generated by the image generating section 62. Because of this, there is a possibility that simple connection between images makes the images discontinuous and boundary lines are visually recognized undesirably. In view of this, the synthesizing section 64 may implement a filtering process in the time direction on images at connection boundaries. For example, the synthesizing section 64 acquires motion vectors of images, and processes images near the boundary lines between images transmitted from the content server 20 such that the images are advanced to a time point at which the image generating section 62 has generated images.

In addition, the synthesizing section 64 may average, at positions near the boundary lines, the pixel values of the thus-obtained images and images of local-generation areas. For a process of advancing images having been rendered to a time point using motion vectors and a process of synthesizing the images with images of the current time and averaging the pixel values of pixels at positions near the outlines of the images in this manner, the technology of anti-aliasing in the time direction (e.g., TAA: Temporal Anti-Aliasing) can be applied. The output section 66 sequentially outputs, to the display apparatus 16, data of frames synthesized by the synthesizing section 64.

The content server 20 includes an input information acquiring section 70 that acquires the content of user operation from image processing apparatuses 10, a data request acquiring section 72 that acquires a request for image data from the image processing apparatuses 10, a content data storage section 74 that stores data to be used for generation of images, an image generating section 76 that generates images, and a data transmitting section 78 that transmits image data to the image processing apparatuses 10.

The input information acquiring section 70 successively acquires the content of user operation at image processing apparatuses 10. In a case where a plurality of users are participating in implementation of one piece of content, the input information acquiring section 70 acquires the content of user operation from respective image processing apparatuses 10. The data request acquiring section 72 acquires requests for image data from image processing apparatuses 10 for each frame or for each plurality of frames. As mentioned above, the image processing apparatuses 10 may make a request designating the positions of tile images.

In addition, in a case where a plurality of users are participating in implementation of one piece of content, areas for which respective image processing apparatuses 10 make requests may be different. For example, as the processing capability of an image processing apparatus 10 lowers, the size of local-generation areas decreases, and accordingly the number of requested tile images increases, in some possible cases. In addition, the number and positions of tile images requested by an image processing apparatus 10 may be different for each frame.

The content data storage section 74 stores a program of content or model data of objects necessary for generation of images. The image generating section 76 generates images of content on the basis of various types of data stored on the content data storage section 74 and the content of user operation acquired by the input information acquiring section 70. The images may represent an image of the whole area of a frame of a moving image representing content.

In a case where a plurality of users are participating in implementation of one piece of content, the image generating section 76 generates images reflecting operation by all the users. In the case of content in which different users have different virtual viewpoints or lines of sight in a display world, the image generating section 76 generates images for each user, and, in turn, for each image processing apparatus 10 by setting view screens corresponding to the respective virtual viewpoints or lines of sight, and rendering images. Suitably, the image generating section 76 renders high-quality images at high speed by a physically based rendering technique such as ray tracing.

On the basis of requests for image data acquired by the data request acquiring section 72, the data transmitting section 78 compresses and encodes data of requested tile images in images generated by the image generating section 76 as appropriate, and transmits the data to requester image processing apparatuses 10. The data transmitting section 78 may immediately transmit the requested tile images at a time point when the tile images are generated by the image generating section 76. Thereby, time required from generation of the images until the transmission can be shortened, and time differences from images of local-generation areas can be reduced.

The data transmitting section 78 makes it possible to appropriately connect tile images at image processing apparatuses 10, and reconstruct frames by including information about positions on the frame planes in the data of tile images to be transmitted. Note that, as mentioned above, the data transmitting section 78 may transmit data of the whole area of a frame always or according to the situation.

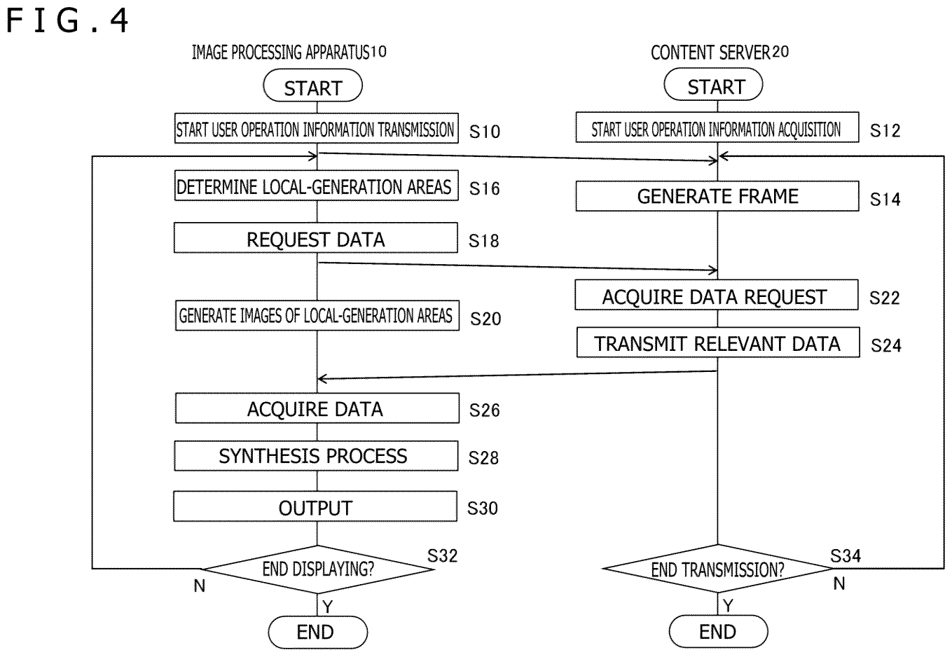

Next, operations performed by the image display system 1 realized by the configuration mentioned above are explained. FIG. 4 is a flowchart depicting a processing procedure performed by an image processing apparatus 10 and the content server 20 to output images of content in the image display system 1. Note that the figure depicts respective processing steps as being performed as a sequence, but some processes may be performed in parallel. In addition, as a step prior to this flowchart, an opening screen is displayed on the display apparatus 16 in response to selection of content by a user at the image processing apparatus 10, and activation of an application. In addition, communication between the image processing apparatus 10 and the content server 20 is established.

First, every time the content of user operation is acquired via the input apparatus 14, the image processing apparatus 10 starts a process of transmitting information about the content to the content server 20 (S10). In response to this, the content server 20 starts acquisition of the transmitted information about the user operation (S12), and generates a frame of a moving image reflecting the user operation as appropriate (S14). On the other hand, the image processing apparatus 10 determines local-generation areas for a frame that should be displayed next (S16), and requests, from the content server 20, data of images of other areas mainly (S18). As mentioned above, the request may be made in units of tile images.

Furthermore, the image processing apparatus 10 generates images of the local-generation areas determined at S16 (S20). The content server 20 acquires the request for image data transmitted from the image processing apparatus 10 (S22), and transmits, to the requester image processing apparatus 10, data of requested areas in the whole area of the frame generated at S14 (S24). The image processing apparatus 10 acquires the transmitted data of images (S26), synthesizes the images with the images of the local-generation areas generated at S20 (S28), and then outputs the synthesized images to the display apparatus 16 (S30).

While there occurs no necessity of ending the displaying of images in response to user operation, the end of the content, or the like (N at S32), the image processing apparatus 10 repeats the processes at S16, S18, S20, S26, S28, and S30 for subsequent frames. On the other hand, while there occurs no necessity of ending the transmission of (image data (N at S34), the content server 20 repeats the processes at S14, S22, and S24 for the subsequent frames. When it becomes necessary to end the displaying of images (Y at S32), the image processing apparatus 10 ends all the processes. When it becomes necessary to end the transmission of image data (Y at S34), the content server 20 ends all the processes.

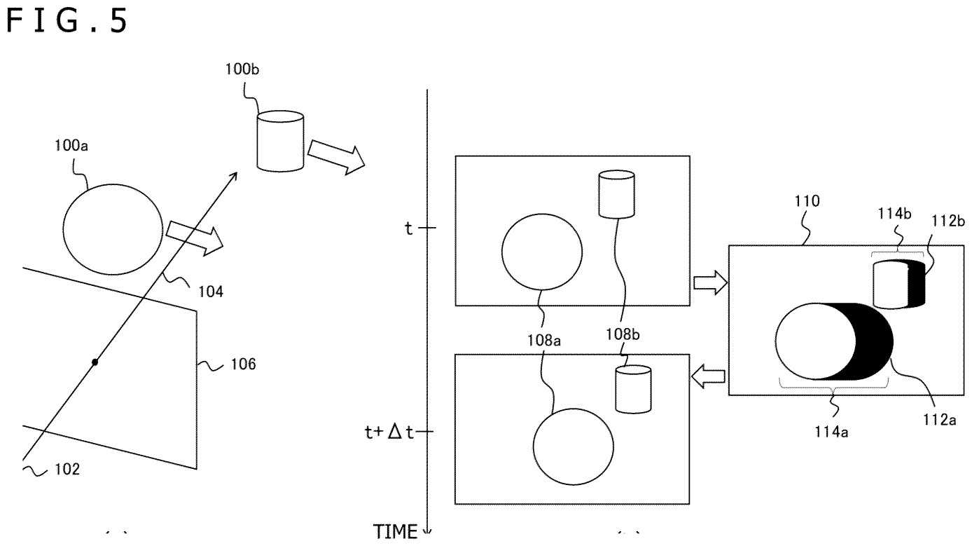

FIG. 5 is a figure for explaining a summary of an image generation technique and the principle of determination of local-generation areas in the present embodiment. (a) schematically depicts a three-dimensional space in which a view screen is set for a display-target space. In the display-target space in this example, there are a spherical object 100a and a cylindrical object 100b. The image generating section 76 of the content server 20 and the image generating section 62 of an image processing apparatus 10 set a view screen 106 on the basis of a viewpoint 102 and a line of sight 104 that determine a display visual field.

For example, in a case where ray tracing is performed, the image generating sections 76 and 62 generate a ray passing through each pixel on the view screen 106 from the viewpoint 102, and determine the pixel value by sampling a color on an object where the ray reaches. By determining the pixel values of all pixels on the view screen 106 in such a manner, an image of one frame can be generated. According to ray tracing, parallelization of processes is easy since the pixel values of respective pixels can be determined by independent computation for each pixel.

An image represented as a frame changes due to movements, deformations, and color changes of the objects 100a and 100b, movements, changes of the color of an emitted ray, and luminance changes of a light source, and furthermore changes of the viewpoint 102 and the line of sight 104. (b) in the figure schematically depicts a frame at a time t and a frame at a time t+Δt, which is the next frame, with the vertical direction as a time axis. It is assumed that, in the display-target space, both the objects 100a and 100b have moved in parallel to the view screen 106 in the right direction as seen in the viewpoint 102 as represented by white arrows in (a).

In this case, as depicted in (b), a spherical image 108a and a cylindrical image 108b move in the right direction of the frame plane. In the example in the figure, since the spherical object 100a is positioned before the cylindrical object 100b, a variable range of the spherical image 108a on the frame plane is larger even if the movement amounts are the same. In addition, the images 108a and 108b vary also due to changes of the view screen 106 caused by changes of the viewpoint 102 and the line of sight 104. Note that, although the movement amounts of the images are expressed in an exaggerated manner for ease of understanding in the figure, the amounts of actual motions between frames are minute amounts.

In order to determine local-generation areas in the frame at the time t+Δt, the local-generation area determining section 54 of the image processing apparatus 10 estimates variable ranges of the images 108a and 108b of the time Δt by using the frame at the time t as the base point.

For example, the paths along which the respective images 108a and 108b move during Δt are determined as in an image 110 from the speeds and moving directions of the objects 100a and 100b. Portions depicted in black in the image 110 are variable ranges 112a and 112b of the images 108a and 108b of the objects.

The local-generation area determining section 54 gives the objects the highest priority ranks in descending order of the area sizes of the variable ranges 112a and 112b. Since the variable range 112a is larger than the variable range 112b in the example in the figure, the spherical object 100a is given the first priority rank, and the cylindrical object 100b is given the second priority rank. Note that, in a case where there are many objects or in other cases, instead of giving priority ranks as numerical values, priorities may be set at a predetermined number of levels corresponding to ranges of the area sizes of variable ranges such as three levels, high/middle/low.

Further, the local-generation area determining section 54 acquires, for the respective objects, local-generation area candidates 114a and 114b obtained by adding the images 106a and 108b of the respective objects in the frame at the time t as the base point to the variable ranges 112a and 112b. The local-generation area determining section 54 selects objects in descending order of priority ranks such that the total area size of the local-generation area candidates 114a and 114b does not exceed the processing capacity set for the processing capacity storage section 68.

For example, in a case where the area size of the local-generation area candidate 114a is equal to or smaller than the processing capacity, but the total of the area size of the local-generation area candidate 114a and the area size of the local-generation area candidate 114b exceeds the processing capacity, the local-generation area determining section 54 sets the spherical object 100a as a rendering target. Further, the local-generation area determining section 54 determines, as a local-generation area, the local-generation area candidate 114a or an area formed by the minimum number of tile images including the local-generation area candidate 114a.

If even the total of the area sizes of the local-generation area candidate 114a and the local-generation area candidate 114b does not exceed the processing capacity, the local-generation area determining section 54 sets both the objects 100a and 100b as rendering targets. In this case, the local-generation area determining section 54 determines, as local-generation areas, the two local-generation area candidates 114a and 114b or an area formed by the minimum number of tile images including the two local-generation area candidates 114a and 114b. In a case where the processing capacity is exceeded only with the local-generation area candidate 114a at the highest priority rank, the local-generation area determining section 54 does not set local-generation areas.

As mentioned above, the local-generation area determining section 54 may predict motions of the objects 100a and 100b at the time t, and derive the variable ranges 112a and 112b or may derive the variable ranges 112a and 112b on the basis of actual motions of the objects 100a and 100b that are made in response to user operation performed during the time Δt from the time t or the like.

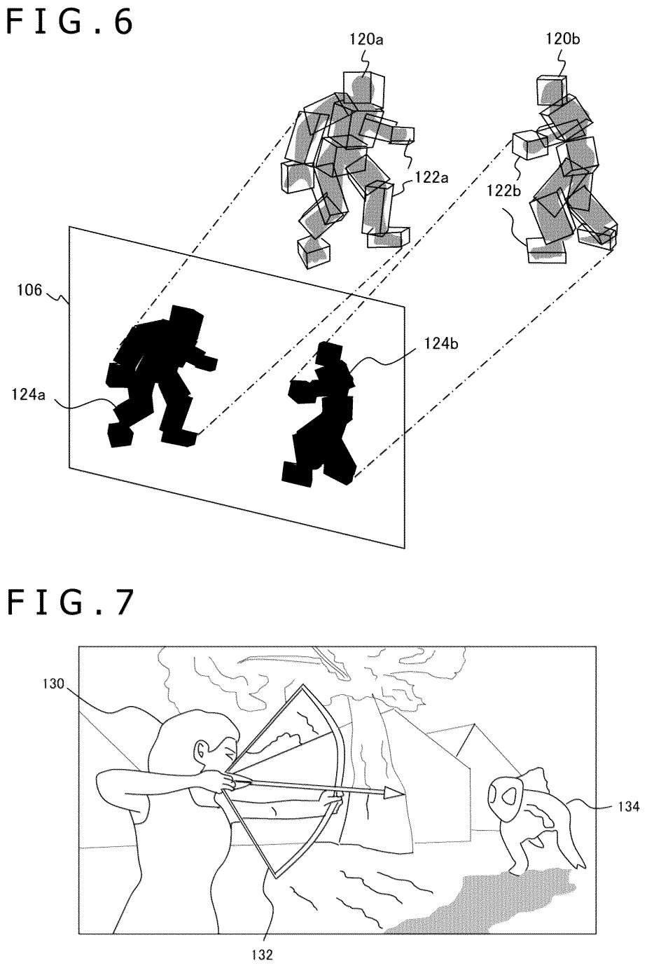

FIG. 6 is a figure for explaining a local-generation area determination technique assuming that there are more complex objects. In this example, there are human objects 120a and 120b in a display-target space. As mentioned above, the local-generation area determining section 54 estimates variable ranges of the images 108a and 108b of the objects of the time Δt by using, as the base point, the state of the objects 120a and 120b at the time t at which a frame has been generated or the like.

In a case where the objects 120a and 120b are targets of user operation estimation, for example, the local-generation area determining section 54 identifies ranges of motion that encompass all moves that the objects 120a and 120b are permitted to make in response to user operation. For example, for each portion of the objects 120a and 120b, the local-generation area determining section 54 generates a bounding box (e.g., bounding boxes 122a and 122b) encompassing a range within which the portion can move during the time Δt. Operation that users can perform and the speed and motion direction of portions in response to each type of operation are specified in a program stored on the content data storage section 60.

For generation of bounding boxes, a technology used in collision detection processes of determining whether or not an object has hit another object in electronic games and the like can be used. Further, the local-generation area determining section 54 projects the generated bounding boxes onto the view screen 106. The thus-generated images 124a and 124b form local-generation area candidates include the images of the objects 120a and 120b at the time t and variable ranges. Stated differently, excluding the images of the objects 120a and 120b at the time t from the areas of the images 124a and 124b gives the variable ranges.

By such a process, variable ranges can be estimated highly precisely relatively easily even for the objects 120a and 120b having complex shapes or making complex motions. In this case also, the local-generation area determining section 54 gives the objects 120a and 120b the highest priority ranks in order of the area sizes of the variable ranges, as explained with reference to FIG. 5. Further, the local-generation area determining section 54 selects objects in descending order of priority ranks, and determines local-generation areas such that the area size of the local-generation area candidates does not exceed the processing capacity of the subject apparatus.

Note that, whereas the bounding boxes of the respective portions are projected onto the view screen 106 as they are in the figure, the present embodiment is not limited to this. For example, the local-generation area determining section 54 may generate, for each of the objects 120a and 120b, a solid with a predetermined shape that encompasses all the bounding boxes forming the object 120a or 120b, and has the minimum volume, and then project the solid onto the view screen 106.

Next, a procedure in which the image processing apparatus 10 determines local-generation areas, and requests data from the content server 20 is explained in terms of an image of a frame. FIG. 7 depicts an example of a frame at the time t as base point in explanation. In a state depicted in this example, an avatar 130 which is the target of user operation is fighting against an enemy 134 by using an arrow 132 as a weapon. FIG. 8 is a figure for explaining a procedure performed by the local-generation area determining section 54 to determine local-generation areas in the frame depicted in FIG. 7.

As explained with reference to FIGS. 5 and 6, the local-generation area determining section 54 first identifies or predicts motions of objects in a three-dimensional space, and then acquires variable ranges of the images on a frame plane. In FIG. 8, the area between the outline of the image of the avatar 130 and a broken line is a variable range 136a of the image of the avatar 130. Similarly, the area between the outline of the image of the arrow 132 and a bold line is a variable range 136b of the image of the arrow 132. The area between the outline of the image of the enemy 134 and a bold line is a variable range 136c of the enemy 134. The area between the outline of the image of a shadow 138 of the enemy 134 and a broken line is a variable range 136d of the image of the shadow 138. Note that, in a strict sense, the variable range 136b of the image of the arrow 132 includes also a variable range of the hands of the avatar 130 that move integrally with the arrow 132.

Further, the local-generation area determining section 54 gives the respective objects priority ranks or priorities according to the area sizes of the variable ranges 136a, 136b, 136c, and 136d. In this example, the variable ranges 136b and 136c represented by the solid lines are given priorities “high,” and the variable ranges 136a and 136d represented by the broken lines are given priorities “middle.” Note that the local-generation area determining section 54 may acquire variable ranges of images of other objects similarly. Alternatively, the local-generation area determining section 54 may handle collectively objects that do not make motions by themselves, and whose images move only due to motions of a view screen, and give the objects the lowest priority rank without determining variable ranges of the objects.

Alternatively, local-generation candidates may be limited according to characteristics of objects. For example, objects that are required to be responsive such as objects which are the targets of user operation and objects that respond to motions of the objects may be extracted according to predetermined conditions, and then variable ranges of the objects may be acquired, and set as local-generation candidates. In addition, objects such as the background that do not make motions and objects that will not cause a problem in terms of responsiveness even if the objects make motions may be excluded from variable-range acquisition targets, and, in turn, from local-generation candidates.

Subsequently, the local-generation area determining section 54 selects rendering-target objects in order of priorities on the basis of the processing capacity of the image processing apparatus 10 to which the local-generation area determining section 54 belongs. For example, the local-generation area determining section 54 selects, as rendering targets, the arrow 132 and the enemy 134 whose priorities are “high.” In a case where the image processing apparatus 10 has a large processing capacity, the local-generation area determining section 54 selects, as rendering targets, also the avatar 130 and the shadow 138 whose priorities are “middle” in addition to the arrow 132 and the enemy 134, in some possible cases.

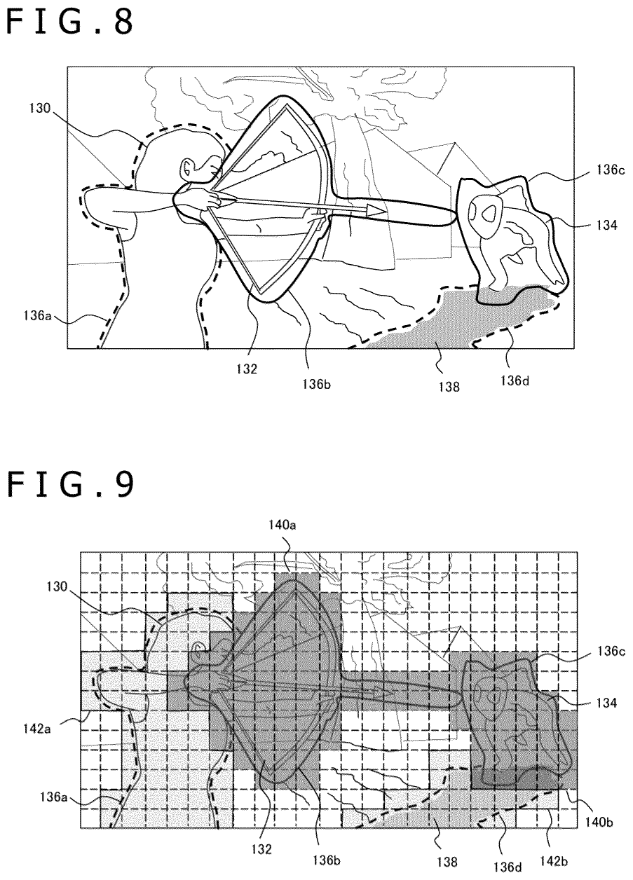

FIG. 9 depicts examples of local-generation areas determined on the basis of variable ranges depicted in FIG. 8 and areas for which data is requested from the content server 20. In a case where the arrow 132 and the enemy 134 are selected as rendering targets, the local-generation area determining section 54 sets, as local-generation areas, an area obtained by combining the respective images in the frame at the time t as the base point and the variable ranges 136b and 136c. Note that, in a case where data is requested from the content server 20 in units of tile images, local-generation areas also may be set in units of tile images.

Grid broken lines that are next to each other at constant intervals on a frame plane in the example depicted in the figure represent the dividing boundaries of tile images. In this case, as depicted in dark gray, the local-generation area determining section 54 sets a local-generation area 140a for the arrow 132, and sets a local-generation area 140b for the enemy 134. For example, the local-generation areas 140a and 140b are formed by a group of the minimum number of tile images including an area formed by combining the respective images at the frame at the time t as the base point and the variable ranges 136b and 136c.

In a case where the avatar 130 and the shadow 138 whose priorities are “middle” are selected as rendering targets also, the local-generation area determining section 54 sets, as local-generation areas 142a and 142b, areas depicted in light gray also. The image generating section 62 of the image processing apparatus 10 renders tile images of the thus-set local-generation areas. Here, the image generating section 62 may render images in order of priorities given by the local-generation area determining section 54. For example, when the local-generation areas 140a, 140b, 142a, and 142b are set, the image generating section 62 first renders the local-generation areas 140a and 140b whose priorities are “high” earlier, and next renders the local-generation areas 140a and 140b whose priorities are “middle.” The data requesting section 56 of the image processing apparatus 10 requests, from the content server 20, data of tile images which are not depicted in gray in the figure other than local-generation areas. Note that requested areas are not limited to these, and, for example, some tile images such as the peripheral portions of local-generation areas may be requested from the content server 20 overlappingly, making it possible for images to be smoothly connected at the time of synthesis. Alternatively, the data requesting section 56 may request data of tile images of the whole area of a frame irrespective of local-generation areas.

In either case, the content server 20 basically generates the whole area of a frame. As a result, it is made possible for data from the content server 20 to cover for images of local-generation areas having not been rendered for some cause at the image processing apparatus 10. Because of this, the data requesting section 56 of the image processing apparatus 10 may transmit, to the content server 20, information about priorities given along with information about local-generation areas acquired by the local-generation area determining section 54. In this case, the content server 20 performs rendering starting from areas with the highest priorities in the whole area of the frame. As a result, image data of areas of particularly high importance can be transmitted to the image processing apparatus 10 immediately as necessary.

In the example in FIG. 8, the variable range 136d of the image of the shadow 138 of the enemy 134 is estimated.

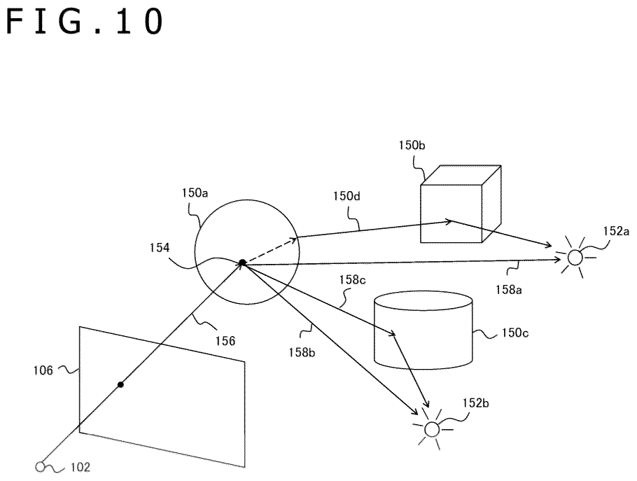

However, in an aspect in which light sources or reflections on surrounding objects are expressed precisely by ray tracing, some images such as shadows or reflections on object surfaces can be identified for the first time by rendering in ray tracing. FIG. 10 is a figure for explaining images determined by ray tracing.

In ray tracing, as mentioned above, a ray passing through each pixel on the view screen 106 from the viewpoint 102 is generated, and the pixel value is determined by sampling a color of a point where the ray reaches. Thereby, not only the color of an object itself due to diffuse reflection, but also shadows, reflections due to specular reflection, images transmitted through semi-transparent objects, and the like can be expressed accurately. In the example in the figure, probabilistically, a ray 156 having reached a point 154 on the surface of a spherical object 150a reaches light sources 152a and 152b (rays 158a and 158b) in some cases and reaches another object 150c due to specular reflection (ray 158c) in some other cases.

In a case where the object 150a is semi-transparent, a ray 150d having been transmitted through the inside of the object from the point 154 and then refracted reaches another object 150b. The ray having reached the other objects 150b and 150c finally reaches the light sources 152a and 152b. The color of the point 154 is represented by superimposed colors of such rays. That is, the color of the point 154 reflects also the colors of the other objects 150b and 150c in addition to the color of the object 150a itself.

As a result, a reflected image of the other object 150c and an image of the object 150b as seen through another object are expressed on the surface of the object 150a. Images of shadows are formed on objects such as an undepicted floor depending on the positional relation between light sources, the other object 150a, and the like.

If the positions and shapes of the objects 150a, 150b, and 150c, the positions of the light sources 152a and 152b, and the like change in such an environment, shadows, images formed due to reflection, images formed due to transmission, and the like change also. In this manner, variable ranges of secondary images on object surfaces that are formed because a plurality of objects are on the paths of rays are difficult to estimate as compared with variable ranges of the objects themselves.

For example, the position of the actual body of another object that is seen through a semi-transparent object can differ depending on the refractive index of the semi-transparent object. Stated differently, which object is seen through, how an image of an object seen through changes when the object moves, and the like can differ depending on the refractive index, and it is difficult to accurately identify them before ray tracing. The same applies also to shadows and reflections.

Because of this, the local-generation area determining section 54 provides exception rules for determination of variable ranges and priorities of those secondary images. For example, in the case of shadows, the local-generation area determining section 54 considers, as a variable range, the difference between an image of a shadow in the frame at the time t as the base point and an area obtained by enlarging the original image by a predetermined scale factor such as 150%. The local-generation area determining section 54 may handle the thus-set variable range in a manner similar to that of variable ranges of other objects, give priorities according to area sizes as depicted FIG. 8, and acquire local-generation area candidates.

In addition, in the case of an object having surface characteristics with a specular reflectivity or a transmittance which is equal to or higher than a predetermined value, the local-generation area determining section 54 sets, as a local-generation area candidate, the whole image of the object. That is, it is not necessary to determine a variable range of an image itself formed due to reflection on a surface or due to transmission, or to set a local-generation area candidate of the image as a unit.

In a case where the object having the surface characteristics described above is stationary, the local-generation area determining section 54 gives the object a predetermined priority which is lower than a priority of another object whose variable range is equal to or greater than a predetermined value. In this case, the local-generation area candidate matches the area of the image of the object. Thereby, the probability that the image generating section 62 speculatively renders the whole image of the object is increased, independently of whether or not there is an image formed due to reflection or transmission or whether or not there is a motion of the image. Note that the local-generation area determining section 54 may check whether or not there is an image formed due to reflection or transmission in the frame at the time t, and, only in a case where there is such an image, give the relevant object a predetermined priority.

In a case where the object having the surface characteristics described above moves by itself, the local-generation area determining section 54 may estimate a variable range of the object by a technique similar to the one mentioned thus far, and give the object a priority according to its area size. In this case, a priority higher than those of other objects having variable ranges with approximately the same areas may be given. By providing the exception rules mentioned above, it is possible to reduce unnaturalness that is caused because a shadow, an image of a reflection, or an image formed due to transmission does not move despite a motion of the object itself or because such an image moves with a delay.

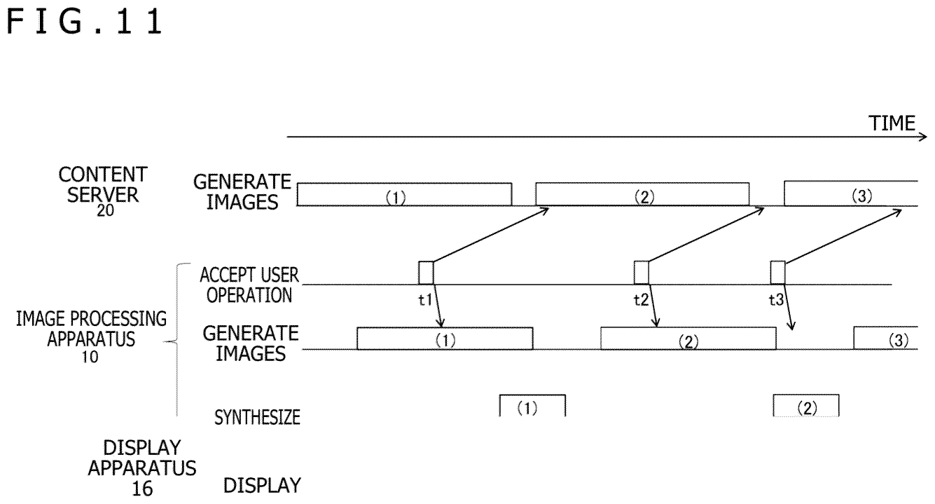

FIG. 11 is a time chart depicting the temporal relation in processes ranging from generation to displaying of each frame. The horizontal direction in the figure corresponds to a time axis. Time of each process depicted in the vertical direction is represented by a rectangle, and also a frame number of a processing target is depicted inside the rectangle. Note that the depicted relation between processing time is an example, and is not aimed to limit the present embodiment.

As depicted in the top line, the image generating section 76 of the content server 20 generates images of frames at predetermined intervals in order of the frame numbers (1), (2), (3), . . . . Data of the generated images is sequentially transmitted to the image processing apparatus 10. As depicted in the second line, a user performs operation via the input apparatus 14 at certain timings (times t1, t2, t3, . . . ), and the image processing apparatus 10 accepts the operation. In addition, as depicted in the third line, the image generating section 62 of the image processing apparatus 10 generates images of local-generation areas in order of the frame numbers (1), (2), (3), . . . .

As represented by solid-line arrows, every time user operation is accepted, the image processing apparatus 10 transmits information about the user operation to the content server 20 and the image generating section 62 of the image processing apparatus 10. Since a signal to the content server 20 is conveyed via the network 8, the content server 20 receives the signal at a timing later than a timing at which the image generating section 62 inside the image processing apparatus 10 receives the signal. Accordingly, in a case where user operation on an image of a local-generation area is performed, the image generating section 62 can cause the user operation to be reflected in the image earlier than the content Server 20 can.

For example, the content server 20 causes user operation accepted at the time t1 to be reflected in a frame numbered (2), but the image processing apparatus 10 can cause the user operation to be reflected in a frame numbered (1). As depicted in the fourth line in the figure, the synthesizing section 64 of the image processing apparatus 10 sequentially synthesizes images from the content server 20 and images of local-generation areas generated by the image processing apparatus 10 in order of the frame numbers (1), (2) . . . . Further, as depicted in the fifth line, the display apparatus 16 sequentially receives image data of frames formed by synthesizing as represented by broken-line arrows, and displays them in order of the frame numbers (0), (1), (2) . . . . By such a procedure, user operation on objects that make large motions can be caused to be reflected in display images in short times.

The axis in the horizontal direction in the figure represents the time axis in the real world. On the other hand, as mentioned above, the content server 20 lags behind the image processing apparatus 10 in terms of the time axis in the image world since the content server 20 receives information about user operation with a delay.

The time from transmission of data from the content server 20 to acquisition of the data by the image processing apparatus 10 also is a cause of time differences of images generated by the content server 20.

In a case where image generation and data transmission are not performed in parallel at the content server 20, it takes time to wait for data transmission, transmit data at once, and so on, and accordingly the time differences increase further. Because of this, as mentioned above, the synthesizing section 64 of the image processing apparatus 10 corrects images generated by the content server 20 and the image processing apparatus 10 such that time differences between the images are not visually recognized, and then synthesizes the images.

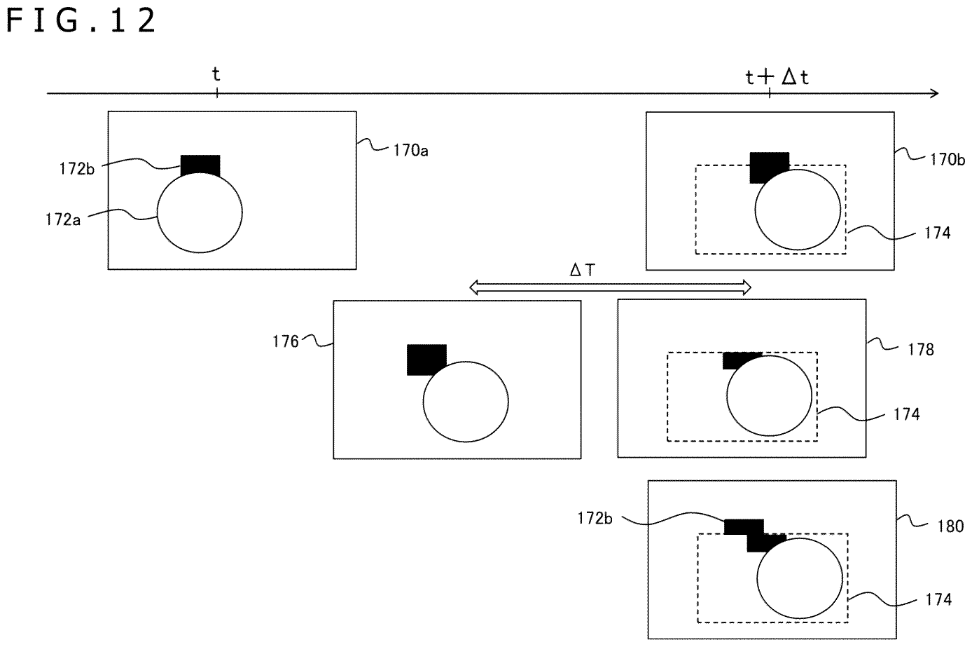

FIG. 12 is a figure for explaining a synthesis process performed by the synthesizing section 64. The horizontal direction in the figure represents the time axis, and the top line depicts a frame 170a at the time t and a frame 170b at the next time t+Δt. In this example, the frames 170a and 170b represent states where there is a black cubic object behind a white spherical object. In a case where the white spherical body moves in the right direction at high speed, and the cube moves in the right direction at low speed, respective images 172a and 172b change as depicted in the figure.

In order to generate the frame 170b at the time t+Δt, the image processing apparatus 10 sets a local-generation area 174 by setting the spherical object moving at high speed as a rendering target. Further, as depicted in the second line, the content server 20 generates a frame 176, and the image processing apparatus 10 generates the local-generation area 174 in a frame 178, but there is a time difference of ΔT between image worlds represented by the frames as mentioned above. If they are synthesized as they are, as depicted in a frame 180 in the third line, the cubic image 172b becomes discontinuous at the boundary of the local-generation area 174 undesirably.

In view of this, the synthesizing section 64 generates an image that is advanced, by ΔT using a motion vector, a portion generated by the content server 20 in an image that crosses the boundary of the local-generation area 174, and then synthesizes the image. In the example in the figure, the upper half of the image 172b of the cubic object moves in the right direction. Thereby, the frame 170b in a state where the images are connected smoothly, and the boundary line is difficult to be visually recognized can be generated.

Note that, whereas the figure depicts the movement amount and discontinuity of an image in an exaggerated manner for ease of understanding, they are minute amounts actually. Accordingly, using a principle similar to that of anti-aliasing that makes the outlines of images smooth, the synthesizing section 64 may shift only pixels in a predetermined range from a boundary line, and connect both images smoothly. In addition, whereas only discontinuity occurs since it is assumed in the figure that an image moves in parallel to the boundary line, it is possible that part of an image is missing depending on a movement aspect in a case where the image moves across the boundary line or in other cases.

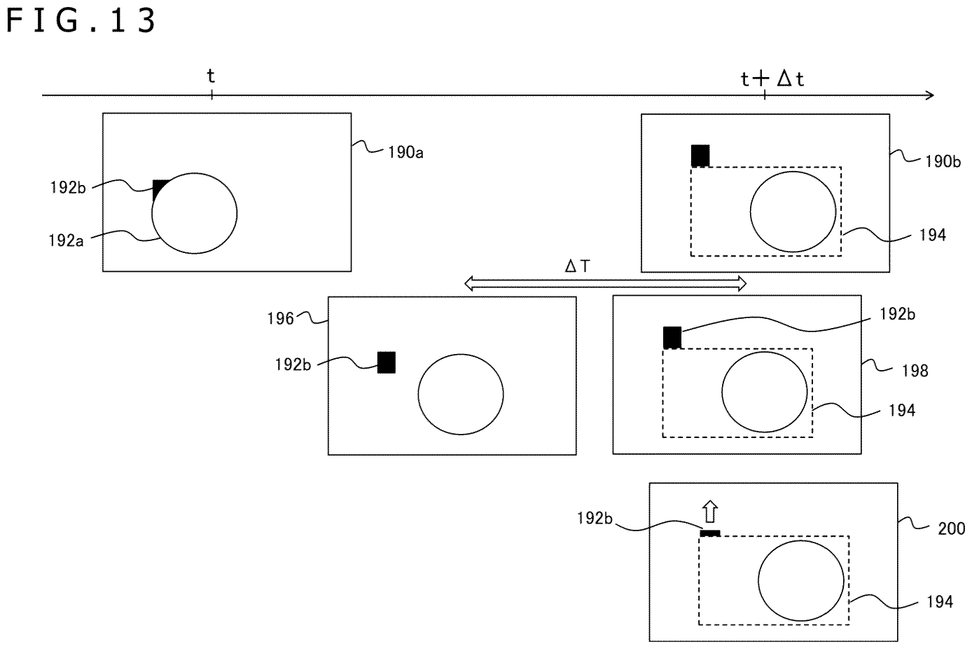

FIG. 13 is a figure for explaining another example of the synthesis process performed by the synthesizing section. The manner of representation of the figure is similar to that of FIG. 12, and the top line depicts a frame 190a at the time t and a frame 190b at the next time t+Δt. In this example also, the frames 190a and 190b represent states where there are a white spherical object and a black cubic object, but it is assumed that the former moves in the right direction, and the latter moves in the upward direction. As a result, respective images 192a and 192b change as depicted in the figure.

In order to generate the frame 190b at the time t+Δt, the image processing apparatus 10 sets a local-generation area 194 setting the spherical object moving as a rendering target. Further, as depicted in the second line, the content server 20 generates a frame 196, and the image processing apparatus 10 generates the local-generation area 194 in a frame 198, but there is a time difference of ΔT between image worlds represented by the frames. Because of this, in the depicted example, the cubic image 192b having been mainly in the range of a local-generation area at a time point when the content server 20 has generated the frame 196 has moved out of the local-generation area 194 at a time point when the image processing apparatus 10 has generated the local-generation area 194.

In this case, if both of the images are synthesized as they are, part of the image 192b is missing as depicted in a frame 200 in the third line, and disappears in some cases. Even if the synthesizing section 64 advances the cubic image 192b by ΔT using a motion vector, and moves the cubic image 192b in the direction of an arrow, part of the image 192b remains missing still due to the lack of an image used for synthesis.

In view of this, the data requesting section 56 of the image processing apparatus 10 may request, from the content server 20, also data of tile images forming the periphery inside the local-generation area. For the peripheral area, even if it is in the local-generation area, an image which has originally been in the local-generation area can be included in the cubic image 192b advanced by ΔT by the synthesizing section 64 by acquiring data generated by the content server 20 in advance. As a result, the frame 190b in a state where part of an image is not missing or has not disappeared can be generated.

Alternatively, the data requesting section 56 may check the moving direction of an image by a motion vector or the like, and, in a case where data is predicted to be insufficient, request, from the content server 20, tile images forming the periphery of a local-generation area for a portion where the data is predicted to be insufficient. Alternatively, if it is sensed that part of an image is missing or has disappeared, the synthesizing section 64 of the image processing apparatus 10 may temporarily expand a local-generation area by requesting the image generating section 62 to render the image.

Note that, in an aspect in which the synthesizing section 64 advances an image generated by the content server 20 by ΔT, there is a possibility that the area outside the frame 196 becomes necessary due to a change of the visual field during ΔT. Because of this, the data requesting section 56 may request, from the content server 20, also data of tile images forming the outer periphery of the range of a frame determined at the time of a data request (e.g., the range of the frame 196). At this time, according to the direction or speed of a change of the visual field until Further, the data requesting section 56 may identify tile images in a range that is predicted to be necessary, and then request the tile images from the content server 20.

According to the present embodiment mentioned thus far, in image processing on electronic content involving distribution from a server, some areas on a frame plane are generated by an image processing apparatus on the side of clients locally, synthesized with images from the server, and displayed. In addition, ranges of local-generation areas generated by the image processing apparatus are determined on the basis of the processing capacity of the image processing apparatus. Thereby, independently of the processing performance of the image processing apparatus, it is possible to enhance responsiveness to user operation while image quality is maintained.

The image processing apparatus sets local-generation areas prioritizing images with large variation between frames. Thereby, it is possible to devote rendering processing load to objects whose motions are noticeable, it becomes easier to maintain the image quality of areas where a user is likely to pay attention, and also delays of images transmitted from the server become less noticeable.

In addition, as for secondary images that are dependent on the paths of rays such as shadows, images formed due to reflections, or images formed due to transmission, it becomes easier for the image processing apparatus to cause the images to move interrelatedly with images of actual object bodies by additionally providing selection criteria regarding local-generation areas. Furthermore, the image processing apparatus corrects images from the server such that the images correspond to a time at which local-generation areas are generated therein, and then synthesizes the images. By doing so, even in a situation where unnaturalness caused by synthesis is likely to occur, the influence of the unnaturalness can be minimized.

The present invention has been explained thus far on the basis of embodiment. It is understood by those skilled in the art that the embodiment is depicted as examples, that various modification examples are possible about combinations of respective constituent elements or respective processing processes of the embodiment, and that such modification examples are also within the scope of the present invention.

### INDUSTRIAL APPLICABILITY

As mentioned above, the present invention can be used for various types of information processing apparatuses such as game apparatuses, head-mount displays, display apparatuses, mobile terminals, and personal computers, and image display systems including any of them, and the like.

### REFERENCE SIGNS LIST

1: Image display system
10: Image processing apparatus
14: Input apparatus
16: Display apparatus
22: CPU
24 GPU
26: Main memory
20: Content Server
50: Input information acquiring section
52: Input information transmitting section
54: Local-generation area determining section
56: Data requesting section
58: Data acquiring section
60: Content data storage section
62: Image generating section
64: Synthesizing section
66: Output section
68: Processing capacity storage section
70: Input information acquiring section
72: Data request acquiring section
74: Content data storage section
76: Image generating section
78: Data transmitting section

1.-15. (canceled)

16. An image processing apparatus comprising:
one or more processors; and
one or more storage devices storing instructions that, when executed by the one or more processors, cause the one or more processors to perform operations comprising:
acquiring data of a moving image from a server,
determining, as a local-generation area, an area on a frame plane of the moving image to be generated locally, based on a content of a previous frame as a reference point,
generating an image of the local-generation area,
synthesizing the moving image acquired from the server and the image of the local-generation area for each frame, and
outputting data of a frame formed by the synthesis.

17. The image processing apparatus of claim 16, wherein the operations comprise controlling an area size of the local-generation area according to a processing capacity of the one or more processors.

18. The image processing apparatus of claim 16, wherein the operations comprise assigning an image of an object to the local-generation area according to a priority that increases as a variable range of an image of the object in the frame increases.

19. The image processing apparatus of claim 16, wherein the operations comprise:
setting, as local-generation area candidates, areas including images of objects and variable ranges of the images of the objects, and
determining the local-generation area from the local-generation area candidates such that a processing capacity of the one or more processors is not exceeded.

20. The image processing apparatus of claim 18, wherein the operations comprise generating images in descending order of priorities assigned to a plurality of local-generation areas.

21. The image processing apparatus of claim 18, wherein the operations comprise identifying a range of motion of an object in a three-dimensional space and estimating the variable range of the image of the object based on the identified range of motion.

22. The image processing apparatus of claim 21, wherein the operations comprise:
identifying a range that encompasses a motion that an object is permitted to make in response to a user operation, and
acquiring the variable range corresponding to the range of the motion.

23. The image processing apparatus of claim 21, wherein the operations comprise:
identifying an actual range of the motion of an object according to an actual user operation, and
acquiring the variable range corresponding to the actual range of the motion.

24. The image processing apparatus of claim 16, wherein the operations comprise:
determining the local-generation area in units of tile images formed by dividing the frame plane into a predetermined size, and
requesting, from the server, data of the tile images excluding at least part of the local-generation area.

25. The image processing apparatus of claim 24, wherein the operations comprise checking a moving direction of an image in the frame, and requesting, from the server, data of the tile images in the local-generation area predicted to be necessary at time of synthesis.

26. The image processing apparatus of claim 16, wherein the operations comprise correcting the image acquired from the server into an image that is advanced by a predetermined time by using a motion vector, and synthesizing the advanced image with the image of the local-generation area.

27. The image processing apparatus of claim 19, wherein the operations comprise setting, as a local-generation area candidate, an area obtained by enlarging an area of an image of a shadow in the frame by a predetermined scale factor.

28. The image processing apparatus of claim 18, wherein the operations comprise identifying an object having a surface where an image of another object is formed by reflection or transmission, and including an image of the identified object in the local-generation area at a predetermined priority.

29. A computer-implemented method comprising:
acquiring data of a moving image from a server;
determining, by one or more processors, as a local-generation area, an area on a frame plane of the moving image to be generated locally, based on a content of a previous frame as a reference point;
generating an image of the local-generation area;
synthesizing the moving image acquired from the server and the image of the local-generation area for each frame; and
outputting data of a frame formed by the synthesis.

30. The method of claim 29, further comprising controlling an area size of the local-generation area according to a processing capacity of the one or more processors.

31. The method of claim 29, further comprising assigning an image of an object to the local-generation area according to a priority that increases as a variable range of an image of the object in the frame increases.

32. The method of claim 29, further comprising:
setting, as local-generation area candidates, areas including images of objects and variable ranges of the images of the objects, and
determining the local-generation area from the local-generation area candidates such that a processing capacity of the one or more processors is not exceeded.

33. The method of claim 31, further comprising generating images in descending order of priorities assigned to a plurality of local-generation areas.

34. The method of claim 31, further comprising identifying a range of motion of an object in a three-dimensional space and estimating the variable range of the image of the object based on the identified range of motion.

35. One or more non-transitory computer-readable storage media storing instructions that, when executed by one or more processors, cause the one or more processors to perform operations comprising:
acquiring data of a moving image from a server;
determining as a local-generation area, an area on a frame plane of the moving image to be generated locally, based on a content of a previous frame as a reference point;
generating an image of the local-generation area;
synthesizing the moving image acquired from the server and the image of the local-generation area for each frame; and
outputting data of a frame formed by the synthesis.
